(19) United States
(12) Patent Application Publication
(10) Pub. No.: US 2008/0113701 A1
(43) Pub. Date: May 15, 2008

(54) Multi-Hand Blackjack Game and Related Systems

(76) Inventors: David B. Schultz, Henderson, NV (US); Michael J. Mitchell, Las Vegas, NV (US); Christopher Sneddon, Las Vegas, NV (US)

Correspondence Address: STEPTOE & JOHNSON, LLP, 2121 AVENUE OF THE STARS, SUITE 2800, LOS ANGELES, CA, 90067, US

(21) Appl. No.: 11/558,377

(22) Filed: Nov. 9, 2006

(51) Int. Cl. G06F 19/00; A63F 13/00; G07F 17/32

(52) U.S. Cl. 463/12

(57) ABSTRACT

Gaming machines capable of presenting a multi-hand blackjack game are disclosed herein. According to one embodiment, the gaming machine includes a widescreen display, a game controller in communication with the widescreen display, and a plurality of player-activated buttons that are also in communication with the game controller. The game controller presents a multi-hand blackjack game having two or more player blackjack hands for play.

### CROSS-REFERENCE TO RELATED APPLICATIONS

This application is related to co-pending U.S. patent application Ser. No. ______, also filed Nov. 8, 2006, entitled “Multi-Hand Blackjack Game and Related Methods.”

### FIELD OF THE INVENTION

Embodiments disclosed herein are directed to gaming methods and systems that offer a multi-hand blackjack game.

### BACKGROUND

Blackjack is a popular casino table game due to the simplicity of the game, speed of play, and small house advantage. While this table game has been popular, electronic gaming machines, such as slot machines and video poker machines, have surpassed table games in popularity and revenue-generation for a casino. Accordingly, the number of table games in a gaming establishment has been reduced in order to allocate more space to gaming machines. The limited supply of seats at blackjack tables has resulted in higher minimum wagers that intimidate or otherwise deter casino patrons from playing blackjack.

As a result, gaming machines presenting blackjack games have been developed to fill this void. These blackjack games are single-hand games that only allow a player to play one hand at a time because the gaming machines were limited in terms of the size of the game display. As shown in FIG. 1, traditional blackjack gaming machines have CRT (cathode ray tube) displays 2 that are not big enough to clearly display 4 more than one blackjack player hand (and all potential split hands) playing against a dealer hand 6. Additionally, larger CRT displays are difficult to securely mount in a gaming machine and use too much space within a gaming cabinet. Furthermore, in order for a gaming cabinet to accommodate a large CRT display, the gaming cabinet would require a large footprint, thereby decreasing the number of gaming machines that may be placed on a casino floor and thereby reduce casino profitability.

Furthermore, traditional blackjack gaming machines only allow a player to place one initial wager on the game. While the denomination of the wager may be varied, there are constraints as to the amount of the wager on each game. For example, the player has to select a particular denomination (nickels, quarters, or dollars) and the player is limited in the number of maximum credits wagered per hand (e.g., five times the denomination unit). Because a single game can only be played at a given time, the casino return is limited. Stated differently, the player would need to play at a fast pace in order to generate a profitable rate of return for the casino. Furthermore, because players are limited to certain wager amounts, the player's perceived return might be considered too insubstantial to play the video blackjack game, thereby reducing the likelihood that the game is played. Accordingly, what is needed is a blackjack game machine that improves the profitability of a video blackjack gaming machine while providing the excitement of a live table blackjack game.

### SUMMARY

Briefly, and in general terms, various embodiments are directed to gaming machines and methods for playing a multi-hand blackjack game. According to one embodiment, the gaming machine includes a widescreen display, a game controller in communication with the widescreen display, and a plurality of player-activated buttons that are also in communication with the game controller. The game controller presents a multi-hand blackjack game having two or more player blackjack hands for play.

According to another embodiment, the gaming machine located in a casino environment includes a widescreen display, a plurality of player-activated buttons, and a game controller in communication with the widescreen display and the plurality of player-activated buttons. The game controller manages a multi-hand blackjack game having two or more player hands for play. The multi-blackjack game also is played with a single deck and each player hand has a uniform wager.

In yet another embodiment, the gaming machine includes a widescreen display mounted in a gaming cabinet. The gaming machine also includes a game controller in communication with the widescreen display. The game controller also manages a single deck, multiple player-hand blackjack game that allows a player to play two to seven hands of blackjack against a dealer hand. In this embodiment, the wager amounts are uniform for each of the player hands. The gaming machine also includes a means for receiving player input that includes selection of a wager amount and game play actions that include adding an additional card to a player hand, standing, doubling down, splitting, or purchasing insurance.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of a prior art gaming machine having a 4:3 aspect ratio display.

FIG. 2 is a perspective view of one embodiment of a gaming machine presenting a multi-hand blackjack game.

FIG. 3 is a block diagram of a control system suitable for operating a gaming machine presenting a multi-hand blackjack game.

FIGS. 4A-4G illustrate the game screens for one embodiment of the multi-hand blackjack game.

FIG. 5 is a functional block diagram of one method of presenting a multi-hand blackjack game.

FIG. 6 is a functional block diagram of one method of presenting a multi-hand blackjack game that includes a bonus game.

FIG. 7 is a block diagram of a system suitable for implementing one embodiment of multi-hand blackjack game.

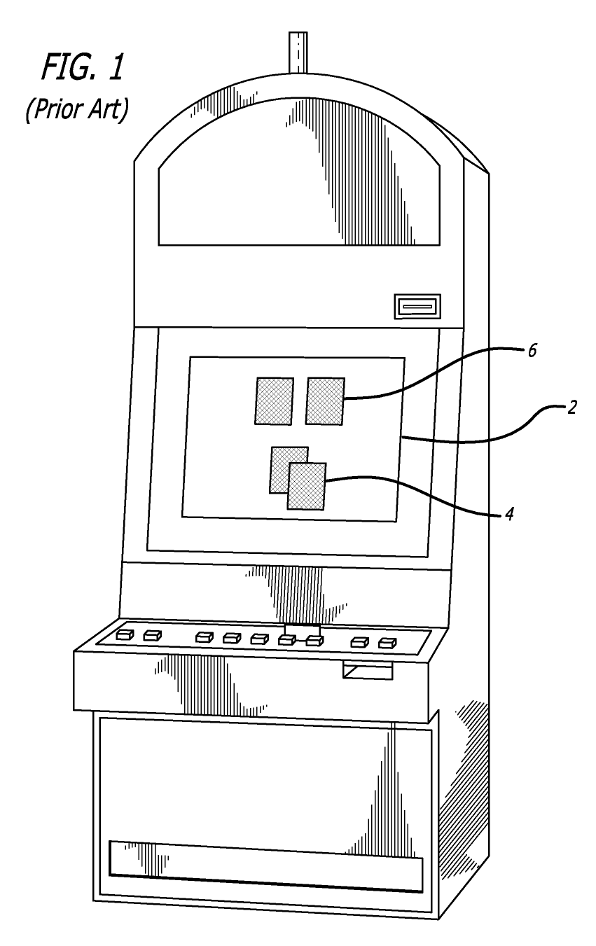

### DETAILED DESCRIPTION

Various embodiments are directed to electronic gaming machines, gaming systems, and related methods directed to presenting a multi-hand blackjack game. The multiple hand (multi-hand) blackjack game allows a player to play at least two hands against a dealer hand in one gaming machine. Furthermore, the widescreen display of the gaming machine allows a player to view all of the player hands and the dealer hand on a single display. According to one embodiment, the multi-blackjack hand allows a player to play up to seven hands of blackjack against the dealer hand. As those skilled in the art will appreciate, the number of playable hands may be greater than seven.

According to one embodiment, the multi-hand blackjack game is played with a single deck of playing cards having fifty-two cards. After each game is played, the single deck is shuffled prior to dealing a subsequent game. Because the game is played with a single deck, the player wagers for each hand is equal in order to maintain the house advantage. That is, if a player is able to select varying wagers, the player may place small wagers on the initial hands and larger wagers on the last hand in order to count cards and swing the advantage in favor of the player. In the event that the player has selected to play a maximum number of hands (e.g., seven blackjack hands) and there is not a sufficient number of remaining cards in the single deck to play a hand (either player or dealer) or to determine whether one or more player hands is a winning hand, each player hand will be a winning hand. In another embodiment, the multi-hand blackjack game is played with multiple decks.

In another embodiment of the multi-hand blackjack game, a preselected triggering event initiates a secondary game. In yet another embodiment, the preselected triggering event initiates a bonus game. In yet another embodiment, the preselected triggering event results in a progressive jackpot award.

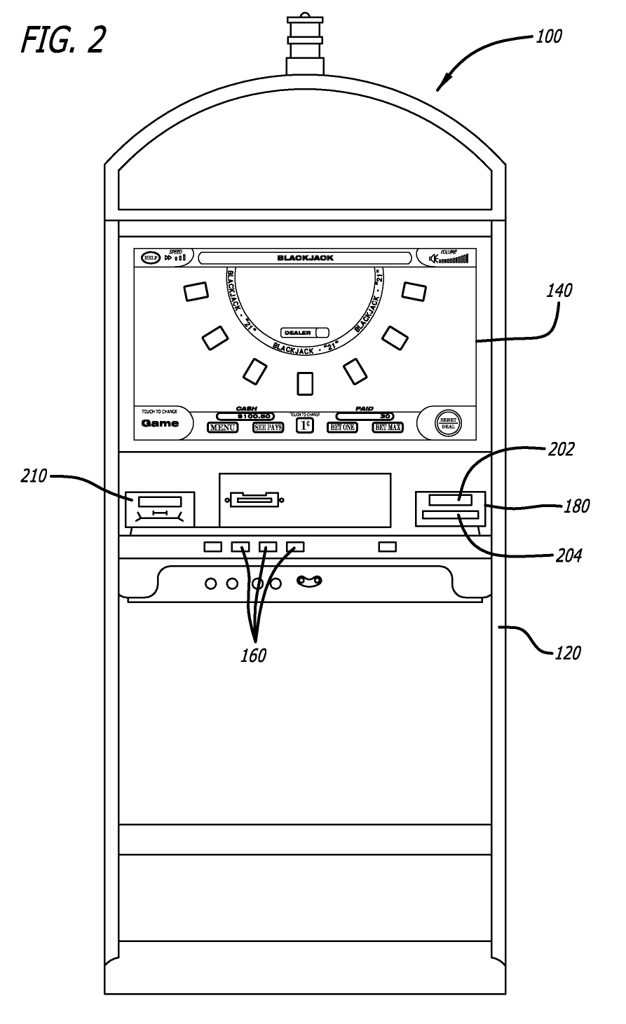

Referring to the drawings, and specifically to FIGS. 2-4G, there is shown one embodiment of a gaming device having a multi-hand blackjack game. Specifically, the gaming device 100 includes a cabinet housing 120 that accommodates a game display 140 and a plurality of player-activated buttons 160. As shown in FIG. 2, the cabinet 120 is a self-standing unit that is generally rectangular in shape. In other embodiments, the cabinet (not shown) may be, without limitation, a table-top style cabinet, or a slant-top cabinet. Any shaped gaming cabinet may be used with any embodiment.

As shown in FIG. 2, the cabinet 120 houses a widescreen display 140 (i.e., 16:9 aspect ratio display) that presents a game of chance such as a multi-blackjack game. In one embodiment, the display 140 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing). The widescreen display 140 is able to accommodate the maximum number of multiple blackjack hands that are available for play. Furthermore, the widescreen display 140 may also display one or more split hands for each of the maximum number of blackjack hands without creating overly small card images that would be difficult to see by the player.

According to one embodiment, the widescreen display 140 may be mounted in the gaming cabinet 120 in a portrait or landscape orientation. In another embodiment, the game display 140 may also include a touch screen or touch glass system (not shown). The touch screen system allows a player to input choices without using any electromechanical buttons 160. Alternatively, the touch screen system may be a supplement to the electromechanical buttons 160.

In alternate embodiments, the cabinet 120 may house a widescreen display 140 in addition to one or more displays (not shown). The additional displays may be used to display a pay table, animation, top box artwork, progressive jackpot information, advertising, help menus, or any game-related or general interest information. The additional display may also present a secondary game such as, but not limited to, mechanical slots, video slots, video keno, video poker, video roulette, or Class II bingo. In alternate embodiments, the additional display may present games of skill or games of chance involving some player skill.

As shown in FIG. 2, the gaming machine 100 includes a plurality of player-activated buttons 160. These buttons 160 may be used for various functions such as, but not limited to, selecting a wager denomination, selecting a number of games to be played, selecting the wager amount per game, initiating a game, or cashing out money from the gaming machine 100. While the buttons 160 shown in FIG. 2 are mechanical buttons, a touch screen system, touch pad, track ball, mouse, switches, toggle switches, or other input means may be used to accept player input.

In an alternate embodiment, a cellular phone or other input device (e.g., PDA), separate and apart, from the gaming machine may also be used to input various player choices and information to enhance the player's interactive experience with the gaming machine. Furthermore, inputting information via these devices provides an added level of security as any key presses may be hidden from view. In yet another embodiment, a player may call or send a text message or a short message service (SMS) to the gaming machine.

As shown in FIG. 2, the gaming machine 100 includes a cashless gaming system 180. The cashless gaming system 180 includes a ticket printer and ticket reader that are provided on the gaming machine 100. The ticket printer and ticket reader may be separate or integral components. As shown in FIG. 2, the ticket reader and the ticket printer have separate slots 202, 204 for receiving and issuing tickets, respectively. Alternatively, the same slot (not shown) may be used to insert and/or issue a ticket. In one embodiment, the ticket reader (not shown) of the cashless gaming system 180 is capable of accepting previously printed vouchers, paper currency, promotional coupons, or the like. The ticket printer (not shown) of the cashless gaming system 180 generates vouchers having printed information that includes, but is not limited to, the value of the voucher (i.e., cash-out amount) and a barcode that identifies the voucher.

Additionally, in another embodiment, the gaming machine 100 is in communication with a player tracking system 210. The player tracking system 210 allows a casino to monitor the gaming activities of various players. Additionally, the player tracking system 210 is able to store data relating to a player's gaming habits. That is, a player can accrue player points that depend upon the amount and frequency of their wagers. Casinos can use these player points to compensate the loyal patronage of players. For example, casinos may award or “comp” a player free meals, room accommodations, tickets to shows, and invitations to casino events and promotional affairs.

Typically, the player tracking system 210 is operatively connected to one or more input components on the gaming machine 100. These input components include, but are not limited to, a slot for receiving a player tracking card, a keypad or equivalent, an electronic button receptor, a touch screen and the like. The player tracking system 210 may also include a database of all qualified players (i.e., those players who have enrolled in a player rating or point accruing program). Generally, the database for the player tracking system 210 is separate from the gaming machines 100.

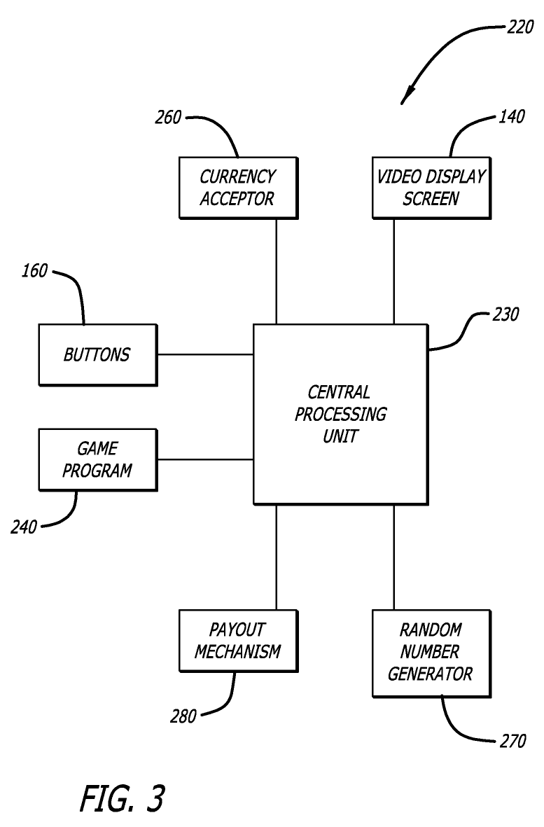

FIG. 3 is a block diagram of an operating system 220 suitable for operating the gaming device 100. According to one embodiment, the operating system includes a central processing unit (CPU) 230 that executes a game program 240 that causes the video display screen 140 to display a base game (e.g., multi-hand blackjack game) that includes an initial set of two simulated cards. According to one embodiment, a currency acceptor 260 signals the CPU 230 when a player has inserted a form of currency such as, for example and without limitation, paper currency, coins or tokens, cashless tickets or vouchers, electronic funds transfers, or the like. The player controls the operation of the gaming device 100 (e.g., selecting the number of hands to play, wager amount, or game play actions) via electromechanical buttons 160 or touchscreen buttons (not shown). The multi-hand blackjack game starts in response to the player further pulling a lever or pushing one of buttons 160. A random number generator 270 responds to instructions from the CPU 230 to provide a randomly shuffled deck or shoe from which cards are dealt. The CPU 230 deals cards that are displayed on video display screen 140. In response to instructions from the CPU 230, any winning hand is paid according to the rules of the game and is provided to the player in the form of coins or credits by payout mechanism 280.

In various embodiments, the game program 240 may be stored in a memory (not shown) comprising a read only memory (ROM), volatile or non-volatile random access memory (RAM), a hard drive or flash memory device or any of several alternative types of single or multiple memory devices or structures.

It should be appreciated that not all gaming devices 100 will have all these components and may have other components in addition to, or in lieu of, those components mentioned here. Furthermore, while these components are viewed and described separately, various components may be integrated into a single unit in some embodiments.

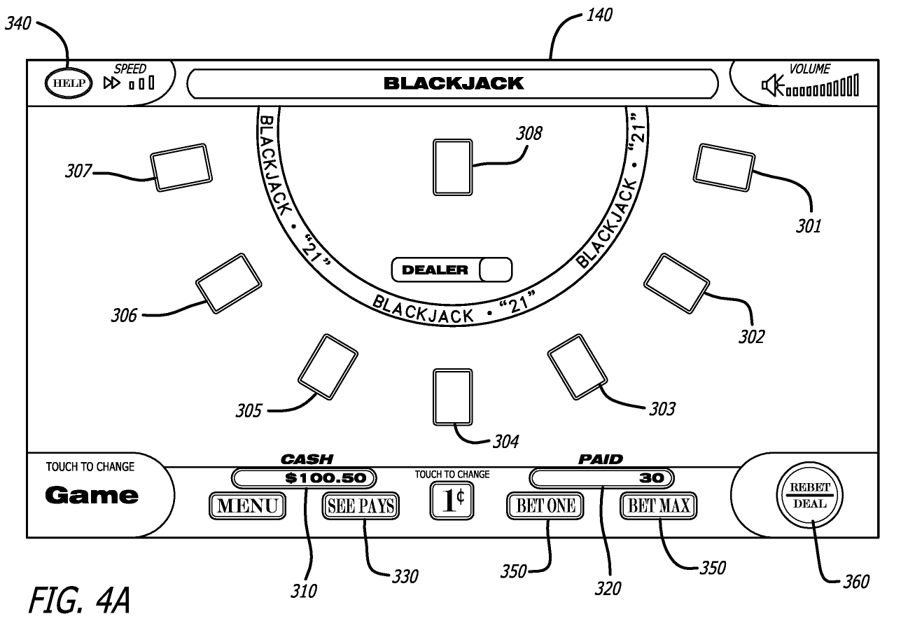

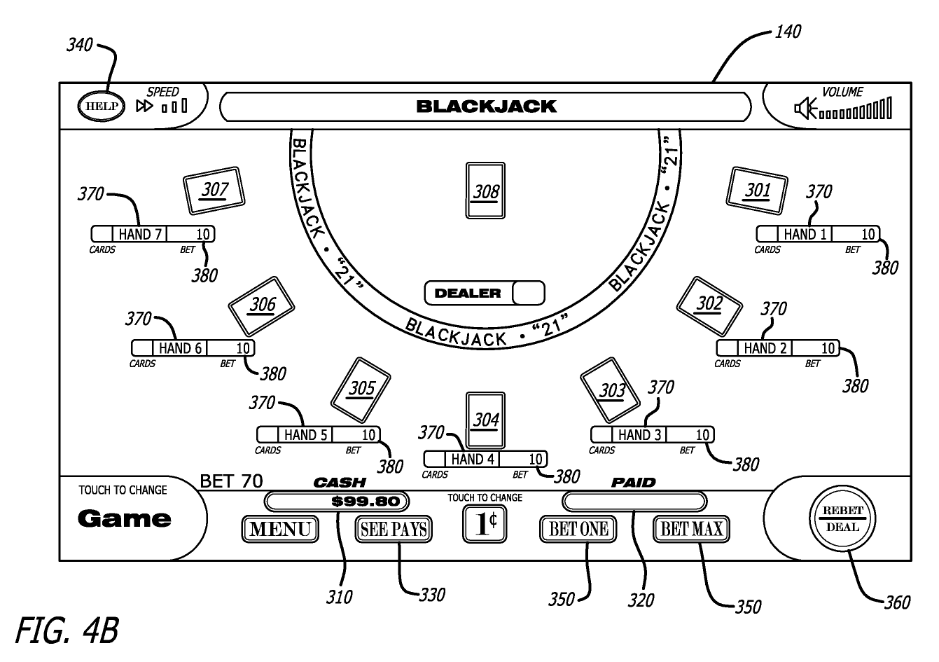

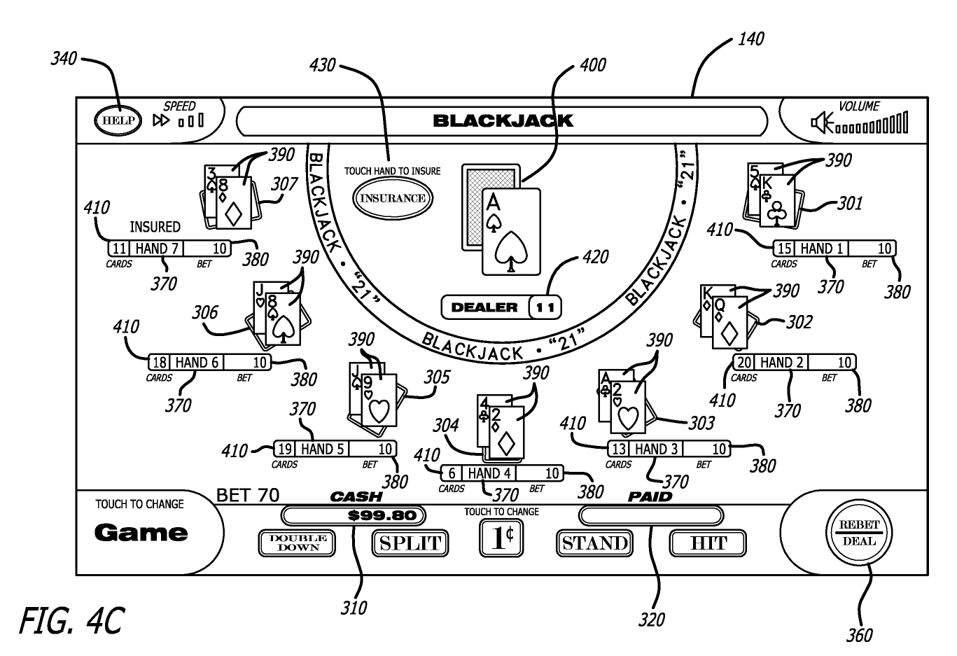

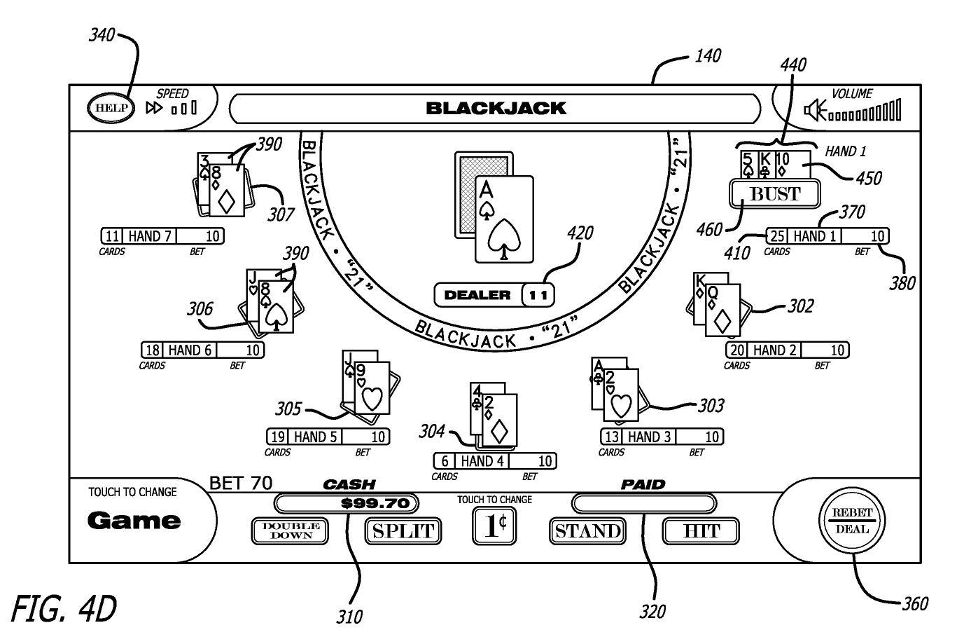

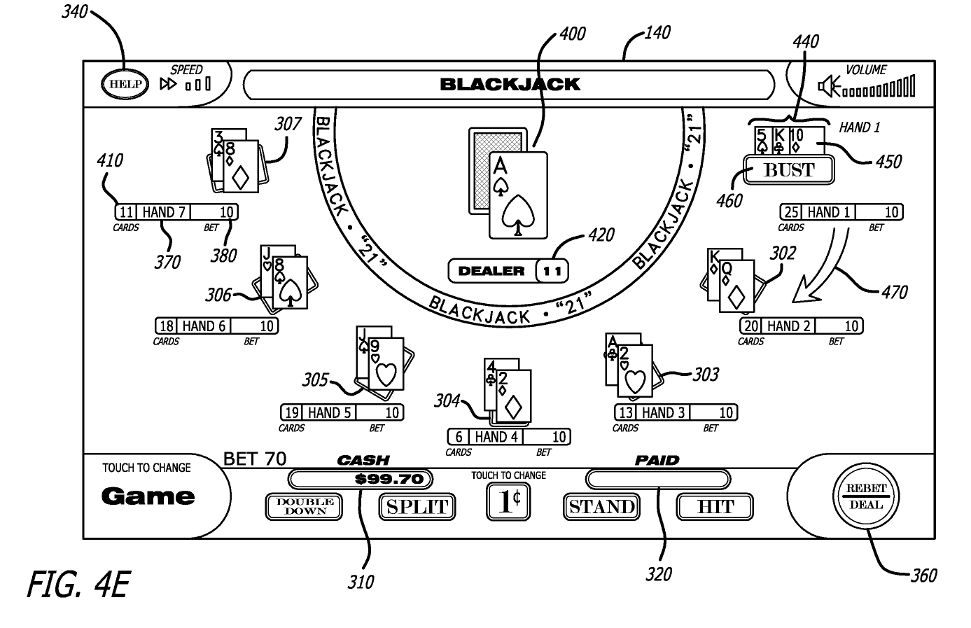

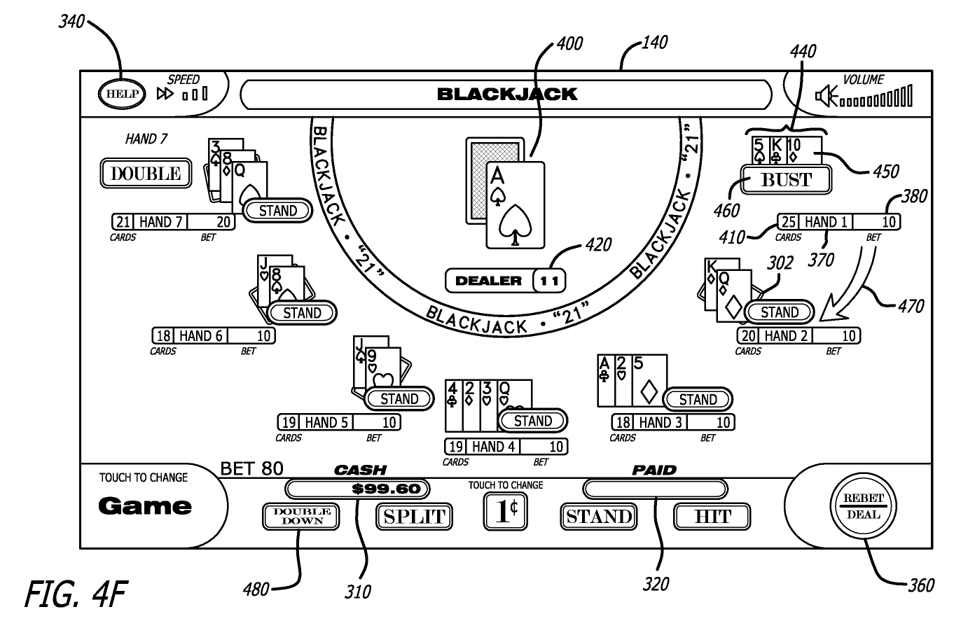

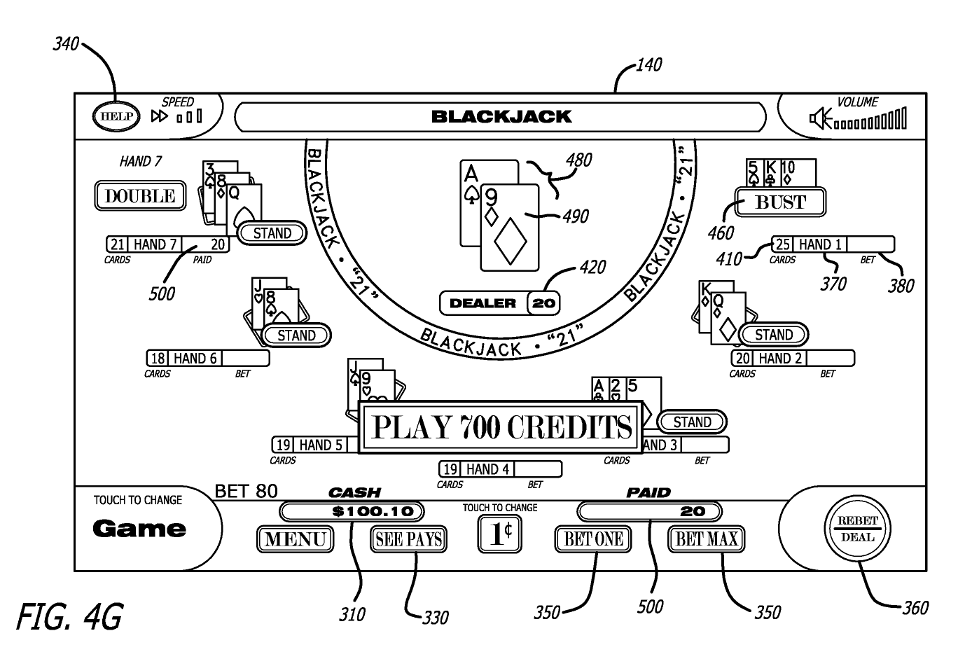

Turning now to FIG. 4A, a screenshot of a multi-hand blackjack game is shown on the widescreen video display 140. As shown in the screenshot of FIG. 4A, the video display 140 presents a plan view of a blackjack table having seven simulated player hand positions 301, 302, 303, 304, 305, 307, 307 and a dealer hand position 308. As those skilled in the art appreciate, the multi-hand blackjack game may have two or more simulated hand positions. This screenshot simulates the view of a traditional table blackjack game. In an alternate embodiment, the screenshot may be a two-dimensional or three-dimensional view of a blackjack table and a plurality of player hand positions. Furthermore, a video image of a dealer may be shown to simulate the dealing and game play of the blackjack game.

As shown in FIG. 4A, the display 140 also presents a credit meter 310 that presents the player's current credit balance (i.e., remaining credits for play or redemption). According to the embodiment shown in FIG. 4A, the display 140 has an optional meter that displays the last amount of the last winning outcome. In other embodiments, additional meters 320 may be presented on the display screen that contain information such as the number of credits awarded to the player per game.

According to the embodiment shown in FIG. 4A, the SEE PAYS button 330 accesses a pay table (not shown) that displays the payout for winning outcomes of the blackjack game. Alternatively, a help button 340 may be activated to access the pay table. Once the SEE PAYS button 330 or the help button 340 is activated, the pay table may be presented on the main display screen 140. Alternatively, the pay table is presented on a secondary video display (not shown). In another embodiment, the pay table is printed on a display (e.g., by silk screening) that is attached to the gaming device (e.g., a “pay glass.”) The pay table information may be presented in terms of odds (e.g., “Blackjack pays 3 to 2”) or relative to a single-coin wager (e.g., “Blackjack pays 2 coins”). Alternatively, some video representations of pay tables may factor in the amount of the player's wager and no additional award adjustment is required by the player to determine the size of a win.

According to one embodiment, the player selects the active player hand positions by touching the corresponding player hand position 301, 302, 303, 304, 305, 306, 307 on the touchscreen or touch glass. In another embodiment, the player selects the desired number of hands and the CPU 230 automatically selects the hand positions moving from right-to-left or vice versa. As shown in FIG. 4A, the player is able to select the wager for the selected using touch screen selection buttons 350 that correspond to incremental bets of one credit or a maximum wager. In other embodiments, the player may select the wager for a hand using electromechanical buttons, a toggle switch, or any means of receiving player input. According to one embodiment of the multi-hand blackjack game, the wager selected by the player is applied to each and every active blackjack hand. Stated differently, the wager for each active hand is the same in order to maintain the house advantage for the game.

As shown in FIG. 4A, the display screen 140 also provides a REBET/DEAL button 360 that allows a player to initiate game play. Alternatively, corresponding buttons 160 on the gaming device control panel (FIG. 2) may be used in conjunction with or in lieu of the touchscreen buttons 350 to perform any of the actions described herein.

The multi-hand blackjack game may be played according to the set of rules provided in Table 1, which are meant to be exemplary and not intended to be limiting. For example, in another embodiment, the multi-hand blackjack game is dealt from multiple 52-card decks (e.g., 7 decks). Alternatively, Blackjack may pay 3:2 rather than 2:1. However, those skilled in the art will appreciate that one or more of the rules of the blackjack game may be altered to adjust the house or player advantage.

TABLE 1

Game is dealt from a single 52-card deck
Player may play 1 to 7 hands per Game
Dealer stands on all 17's
Blackjack pays 2:1
Insurance pays 3:1
Player may double down on 10 or 11 only
Player may split any pair up to 4 times
Aces may be split up to 4 times, but with only one hit per Ace

With reference to the screenshot in FIG. 4B, the player has elected to play seven hands. According to one embodiment, the active hands are represented by identifiers 370 that note the position (e.g., HAND 1, HAND 2, HAND 3, etc.) of the selected hand. The identifier 370 is presented when the hand position is activated and is presented adjacent to the player position. As shown in FIG. 4B, a bet indicator 380 represents the amount wagered on each hand. In another embodiment, active hand positions are denoted by an outline of a card or hand position. In yet another embodiment, changing the color of the identifiers 370 represents the active hand positions. Alternatively, an icon or symbol (not shown) may represent that a hand position 301, 302, 303, 304, 305, 306, 307 is activated. As those skilled in the art will appreciate, the multi-hand blackjack game may use any means of signifying an active hand position.

As shown in FIG. 4B, bet indicators 380 are associated with each active hand and display the number of credits wagered for that hand. In one embodiment, bet indicators 380 are represented by an image of gambling chips that correspond to the player's wager. Different denominations of chips may be represented by different colors or by any other indicia. As shown in FIG. 4B, the bet indicators 380 show that ten credits (wherein each credit is worth $0.01) have been wagered on each hand. As those skilled in the art will appreciate, any type of bet indicator may be used to represent the player's wager amount.

FIG. 4C is screenshot representation of cards 390 having been dealt to each of the active player hand positions 301, 302, 303, 304, 305, 306, 307 and the dealer hand position 400. As shown in FIG. 4C, the highest possible total for the value of the face-up cards in each of the active player hand positions 301, 302, 303, 304, 305, 306, 307 is reflected by a player card total box on the display 410. According to one embodiment, the dealer's highest value of the face-up-card total is reflected in the dealer card total box 420. For example, the dealer's Ace card may be counted as either 1 or 11, but the highest total value (i.e., 11) is shown in the dealer card total box 420. Similarly, the card total for the third active player hand 303 may be either 3 or 13 (depending on whether the Ace is counted as having a value of one or eleven), but the value shown in the card total player card total box 410 is highest possible total value (i.e., thirteen). In an alternate embodiment, the player card total box 410 may alternate between the two possible card totals (i.e., 3 or 13). The final total evaluation of each hand will always use the highest possible total for comparison between the player's hand and the dealer's hand.

In the example shown in FIG. 4C, the multi-hand blackjack game offers an insurance option with message 430 because the dealer's face-up card is an Ace. If the gaming machine 100 includes a touch screen, the player may touch the cards or areas of the screen near any hand he wishes to insure. Alternatively, the player may select those hands to insure via controls such as, but not limited to, a mouse, trackball or the like may also be used in lieu of a touchscreen. As shown in FIG. 4C, the player has elected to insure HAND 7. If the dealer has “Blackjack,” the player will only lose the initial wager on HAND 7 but will win a matching pay-off on the insurance wager. Alternatively, if the dealer does not have “Blackjack,” the player will lose the insurance wager but not the initial wager.

Turning now to FIG. 4D, the game actions available to the player are shown at the bottom of the display 140. The player is able to “hit” (i.e., draw another card), “stand” (i.e., refuse to draw another card), “double down” (i.e., double the player's initial wager and only drawing one card), or “split” the hand (i.e., match the initial wager and divide the initial hand into two hands for play). As shown in FIG. 4D, the player has hit the first hand 440 (i.e., drawn an additional card 450). The total value 410 has exceed 21 (i.e., total hand value is 25) and the player has lost and has a “bust” hand. Accordingly, an indicator, symbol, or icon (e.g., term “bust”) 460 is shown on or around the hand 440 that has busted.

FIG. 4E is a screen shot illustrating that game play has moved from HAND 1 to HAND 2 by displaying an arrow 470 between the first and second hands. The arrow 470 is shown for illustrative purposes and is not a component of the game. However, the arrow 470 may be displayed in the help menu or in a demonstration mode. In some embodiment of the multi-hand blackjack game, the arrow 470 may be a component of the game. In another embodiment, a halo or ring (not shown) may flash around the active hand. As shown in FIG. 4E, the player has elected to stand. Once the player has selected a game play action (e.g., stand in HAND 2), the player's elected action is displayed on or around the active hand.

FIG. 4F illustrates the game flow of the multi-hand blackjack game. As shown, the game moves from hand-to-hand in a clockwise manner. That is, the game moves in the direction of the arrows 470. As shown in FIG. 4F, the player has elected to draw an additional card and then stand on HAND 3 with a card total of 18. With respect to HAND 4, the player has hit two times (i.e., drawn two additional cards) and then elected to stand with a card total of 19. Turning now to HAND 5, the player has elected to stand without drawing any additional cards thereby having a card total of 19. Game play then turns to HAND 6 where the player has elected to stand with a card total of 18. For HAND 7, the player has pressed the DOUBLE DOWN button 480 and thereby electing to receive only one additional card in exchange for the opportunity to double the initial wager of 10 credits to 20 credits. As shown in FIG. 4F, the player's elected action (i.e. doubling down) is displayed on or around the active hand with the indicator “Double.”

FIG. 4G illustrates the dealer hand 480 being played by the CPU 230. That is, the dealer 480 hand is played after the active player hands have been played. Once the player has finished playing all the active hands, the dealer's hole card 490 (i.e., the card that is face down) is revealed to give the dealer a total hand of 20. Accordingly, the active player hands 301, 302, 303, 304, 305, 306, 307 are compared to the dealer hand 480. A player card total greater than the dealer hand total is a win, and a player card total less than the dealer hand total is a losing hand. If a player card total is the same as the dealer hand total, the player hand “pushes” (i.e., ties) and no win or loss occurs for this player hand. Accordingly, reviewing the player hands in FIG. 4G, the player lost HAND 1 because the player's card total exceeded the maximum of 21. With respect to HAND 2, the player has pushed (i.e., both the player and dealer hands total 20). With respect to HANDS 3, 4, 5, and 6, the player has lost since they player card totals (18, 19, 19, and 18, respectively) are less than the dealer card total of 20. HAND 7, with a total of 21, is a winning hand and pays 20 credits, as shown by pay indicator 500. As shown in FIG. 4G, the total of all winning hands is also reflected on the win paid meter 510.

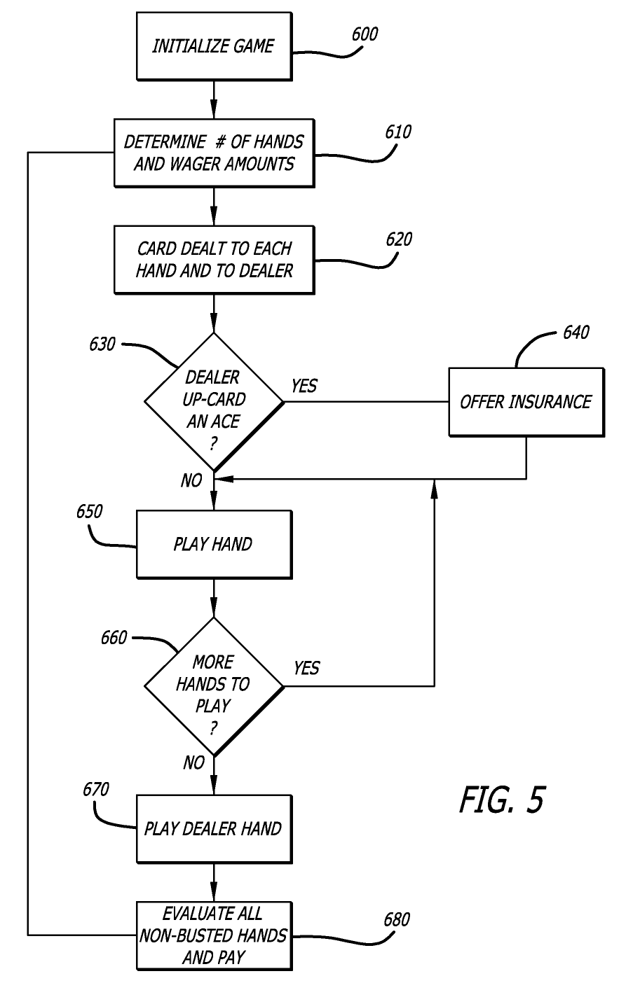

Turning now to FIG. 5, a logical flow diagram generally depicting the acts associated with operating a multi-hand blackjack game. At block 600, game play is initialized when the player inserts credit into the gaming machine. The credit may be in the form of currency (paper or coin), account credits, promotional credits, debit cards, credit cards, or the like. At block 610, the CPU 230 receives player input from the touchscreen or player activated controls, and the CPU 230 determines the number of hands the player has selected to play and the player's selected wager amount. The player's selected wager is then applied uniformly to all of the active hands. That is, the player is not allowed to vary the wager for each of the active hands.

At block 620, a first card is dealt face-up to each active hand positions, and the dealer card is dealt face-down. A second card is then dealt face-up to each active hand position. Then, the dealer card is dealt face-up. In another embodiment, the player cards are dealt face down and then revealed as each hand is played.

After the active player hands and the dealer hand have been dealt, the CPU 230 determines if the dealer's face-up card is an Ace at block 620. If the face-up dealer card is an Ace, the player is provided with the opportunity to buy insurance for one or more of the player's hands at block 630. In an alternate embodiment, at block 620, the CPU 230 determines if the dealer's face-up card has a value of 10 (i.e., 10 or face card). If so, the player is provided with the opportunity to buy insurance at block 640. If the CPU 230 does not receive player input electing to buy insurance, the game continues at block 650, where the CPU 230 processes player input regarding game play (i.e., player makes optional hit, double or split decisions until the hand total busts or the player decides to stand).

At block 660, the CPU 230 determines whether there are additional hands to be played. If the player has wagered on more than one hand, game play at block 650 continues. If there are no remaining player hands to play, game play moves to block 670 where the dealer hand is played.

At block 670, the dealer's face-down card is revealed. If insurance was offered in block 640, insurance wins and losses are resolved for each hand on which an insurance wager was made based on whether the dealer's hand is a blackjack (i.e., an Ace combined with a 10 or a face card). According to the rules of the multi-hand blackjack game, the dealer hits or stands based upon the card total of the dealer's hand. For example, in one embodiment, a dealer hand may be required to stay on all hands totaling 17 or more. In another embodiment, a dealer hand may be forced to hit “soft 17,” (i.e., a hand comprised of an Ace and a 6, the combined value of which is 17 when the Ace is treated as an 11).

Once a total has been established for the dealer's hand, the dealer's hand total is compared to each of the non-busted player hands at block 680. If the dealer's hand total exceeds the total for a particular player hand, the player's hand is lost and no credits are awarded. If the dealer's hand and a particular player hand tie, credits equal to the original wager are returned to the player in a “push.” If the dealer's hand total is less than the player hand total, the player is awarded a win according to the pay table. For example, if the dealer hand total is 19 and the player hand total is 20, the player is awarded credits equal to the original wager plus another equal sized award for the win. In the case of a player hand that resulted in a blackjack (an Ace and a 10 or face card), the player is commonly awarded the base win plus a premium. Any credits paid for the various hands are awarded to the player by, typically, but not limited to, incrementing the gaming machine's credit meter by the amount paid and play resumes at block 610. In the event that the dealer hand has busted, all active player hands that have not busted are winning hands.

In the event that the dealer hand or any player hand cannot be completed (e.g., single deck game and all 52 cards have been used), all the player hands are deemed winning hands and the credit meter is incremented accordingly. For a single deck, multi-hand blackjack game, once the player's active hands are evaluated against the dealer hand, the single 52-card deck is shuffled for the next game. For a multiple deck game, the decks may be reshuffled after every game or the deck is shuffled after a certain number of cards have been played. As those skilled in the art will appreciate, the order of actions as shown in FIG. 5 are merely illustrative and not meant to be considered limiting.

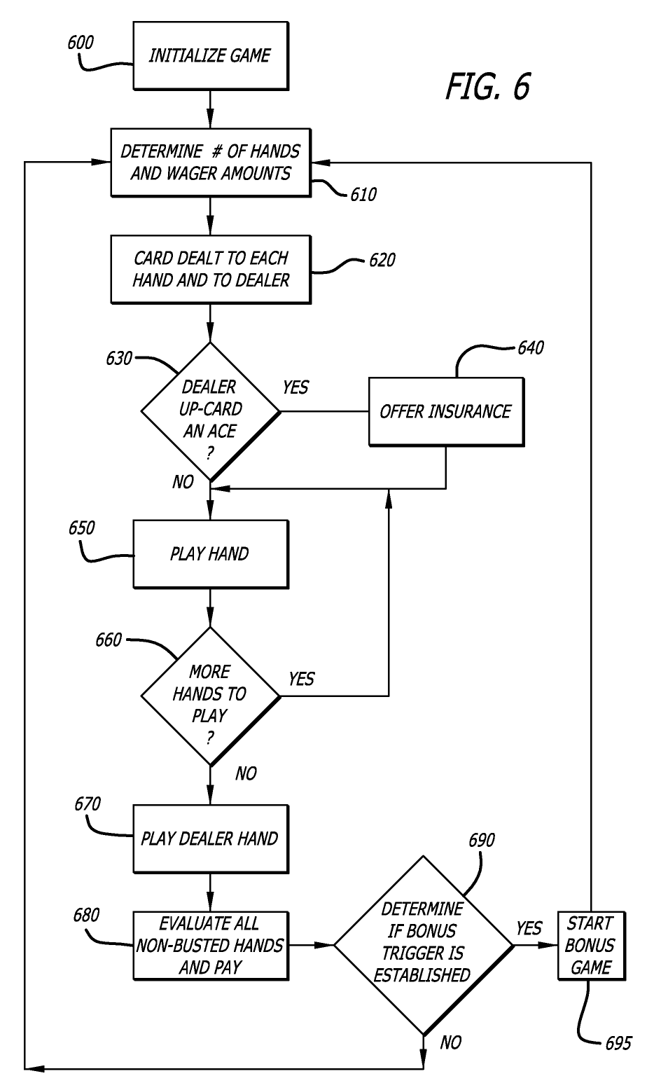

FIG. 6 illustrates a logical flow diagram for managing a multi-hand blackjack game having a bonus game. The logical flow diagram of FIG. 6 is similar to that of FIG. 5 except that after all the hands of the multi-blackjack game have been played, the CPU 230 determines whether a triggering event has been established at block 690. The triggering event is a condition that needs to be satisfied in order to initiate a bonus game at block 695. The triggering event may be a particular game outcome such as, but not limited to, a blackjack hand consisting of an Ace and any suit of a Jack. Alternatively, the triggering event may be winning all active hands (e.g., all seven hands of blackjack). In yet another embodiment, the triggering event may be winning a hand against the dealer where the player has “hit” at least 4 times. In another embodiment, the triggering event is a particular “poker” hand based upon the blackjack hand. For example, if the player's blackjack hand consists of a pair of Jacks or better (e.g., three-of-a-kind, straight, or flush), this will trigger the bonus game. As those skilled in the art will appreciate, the triggering event does not have to be a winning blackjack hand but any possible game outcome may trigger the bonus game.

Additionally, triggering events may be based upon player activity/actions. For example, the triggering event may be based upon player performance such as, but not limited to, inserting a player tracking card into the gaming machine, time of play, rate of play (i.e., number of games player in a particular period of time), number of maximum bets, number of player points earned, or a combination thereof. In another embodiment, a random player performance characteristic may be selected to be the triggering event. For example, a bonus game is triggered when a player has played the multi-hand blackjack game for 30 consecutive minutes. As those skilled in the art will appreciate, one or more of the triggering events may be required to initiate a bonus game.

In another embodiment, the gaming machine presenting a multi-hand blackjack game may include a progressive jackpot. In this embodiment, if a player achieves a predetermined game outcome or triggering event, the player may be entitled to a portion of or the entire progressive jackpot. For example, if the player elects to play the maximum number of hands with maximum wagers and the player receives a blackjack on all of the hands, the player wins the entire progressive jackpot amount. As those skilled in the art will appreciate, any combination of winning outcomes may entitle the player to a portion of or all of the progressive jackpot.

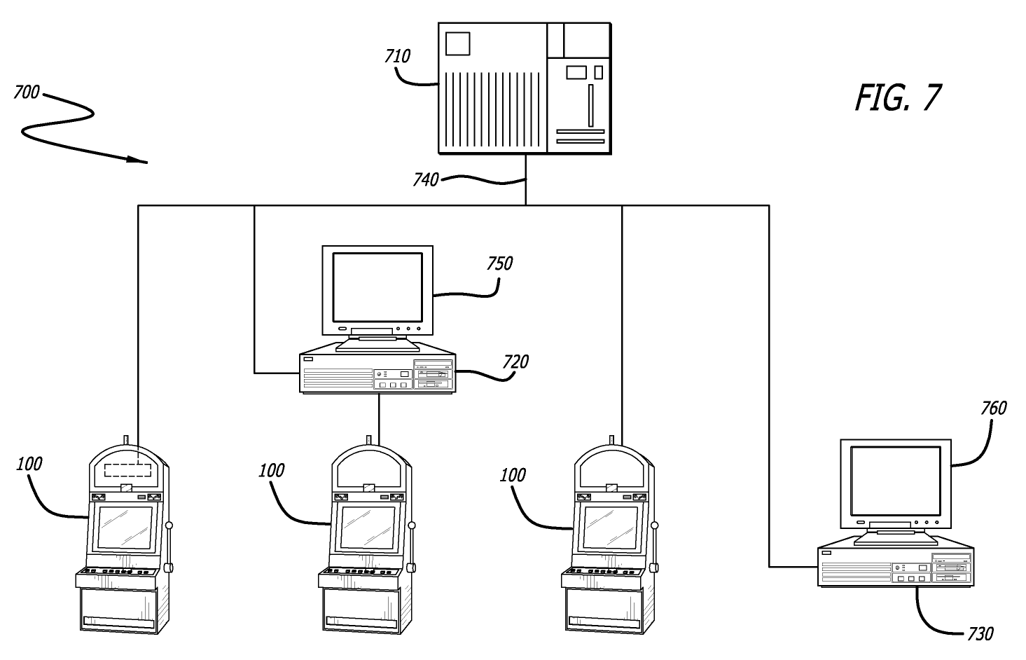

FIG. 7 illustrates one embodiment of a gaming system 700 allows a multi-hand blackjack game to be played in a particular area of a casino (e.g., a carousel) or across one or more casinos located in geographically separate areas through cooperative or competitive play under the control of a system server 710. For example, the players at various betting positions on the displayed blackjack table may reside at more than one gaming machine. The type of server 710 used is generally determined by the platform and software requirements of the gaming system 700. Examples of suitable servers are an IBM RS6000-based server, an IBM AS/400-based server or a Microsoft Windows®-based server, but it should be appreciated that any suitable server may be used. Additionally, the system server 710 may be configured as a “logical” server that comprises multiple physical servers. The gaming machines 100 illustrated in FIG. 7 act as terminals for interacting with a player playing a casino game. Networking components facilitate communications between the system server 710 and game management units 720 and/or gaming display control computers 730 that control displays for carousels of gaming machines 100 across a network 740. Game management units (GMU's) 720 connect gaming machines to networking components and may be installed in the gaming machine cabinet or external to the gaming machine 100. The function of the GMU 720 is similar to the function of a network interface card connected to a desktop personal computer (PC). Some GMU's 720 have much greater capability and can perform such tasks as presenting and playing a blackjack game using a display 750 operatively connected to the GMU 720. Displays related to blackjack games being played on gaming machines 100 or GMU displays 750 may also be presented on gaming displays 760 by gaming display control computer 730. In one embodiment, the GMU 720 is a separate component located outside the gaming machine 100. Alternatively, in another embodiment, the GMU 720 is located within the gaming machine. Optionally, in an alternative embodiment, one or more gaming machines 100 connect directly to a network and are not connected to a GMU 720.

Of course, one will appreciate that a gaming system 700 may also comprise other types of components, and the above illustrations are meant only as examples and not as limitations to the types of components or games used in a casino gaming system having a multi-hand blackjack element.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A gaming machine located in a casino environment, the gaming machine comprising:
a widescreen display;
a game controller in communication with the widescreen display, wherein the game controller presents a multi-hand blackjack game having two or more player blackjack hands for play; and
a plurality of player-activated buttons, wherein the plurality of player-activated buttons are in communication with the game controller.

2. The gaming machine of claim 1, wherein the widescreen display includes a touch screen or touch glass system.

3. The gaming machine of claim 1, wherein the multi-hand blackjack game is played with a single deck of cards.

4. The gaming machine of claim 1, wherein each of the player blackjack hands have an equal initial wager.

5. The gaming machine of claim 1, wherein the multi-hand blackjack game further comprises a bonus game.

6. The gaming machine of claim 1, wherein the game controller further suggests player moves for a given blackjack hand.

7. The gaming machine of claim 1, wherein the gaming machine is in communication with a backend gaming system.

8. The gaming machine of claim 1, wherein the gaming machine is in communication with a progressive jackpot gaming system.

9. A gaming machine located in a casino environment, the gaming machine comprising:
a widescreen display;
a game controller in communication with the widescreen display, wherein the game controller manages a multi-hand blackjack game having two or more player hands for play, and wherein the multi-hand blackjack game is played with a single deck and each player hand has a uniform wager; and
a plurality of player-activated buttons, wherein the plurality of player-activated buttons are in communication with the game controller.

10. The gaming machine of claim 9, wherein the widescreen display includes a touch screen or touch glass system.

11. The gaming machine of claim 9, wherein the game controller further manages a bonus game.

12. The gaming machine of claim 9, wherein the game controller further suggests player moves for a given blackjack hand.

13. The gaming machine of claim 9, wherein the gaming machine is in communication with a backend gaming system.

14. The gaming machine of claim 9, wherein the gaming machine is in communication with a progressive jackpot gaming system.

15. A gaming machine located in a casino environment, the gaming machine comprising:
a widescreen display mounted in a gaming cabinet;
a game controller in communication with the widescreen display, wherein the game controller manages a single deck, multiple player-hand blackjack game that allows a player to play two to seven hands against a dealer hand, wherein each player hand has a uniform wager; and
a means for receiving player input that includes selection of a wager amount and game play actions that include adding an additional card to a player hand, standing, doubling down, splitting, or purchasing insurance.

16. The gaming machine of claim 15, wherein the widescreen display includes a touch screen or touch glass system.

17. The gaming machine of claim 15, wherein the game controller further manages a bonus game.

18. The gaming machine of claim 15, wherein the game controller further suggests player moves for a given blackjack hand.

19. The gaming machine of claim 15, wherein the gaming machine is in communication with a backend gaming system.

20. The gaming machine of claim 15, wherein the gaming machine is in communication with a progressive jackpot gaming system.
